(19) United States
(12) Patent Application Publication
(10) Pub. No.: US 2003/0122302 A1
(43) Pub. Date: Jul. 3, 2003

(54) Gaming apparatus

(76) Inventor: Anthony Dennis Boulton, Surrey (GB)

Correspondence Address: SMITH-HILL AND BEDELL, 12670 N W BARNES ROAD, SUITE 104, PORTLAND, OR, 97229

(21) Appl. No.: 10/324,710

(22) Filed: Dec. 19, 2002

(30) Foreign Application Priority Data
Dec. 21, 2001 (GB) 0130599.4

(51) Int. Cl. A63B 71/00; G07F 17/34; A63F 1/00

(52) U.S. Cl. 273/139; 463/20

(57) ABSTRACT

Gaming apparatus (10) comprises symbols providing means for providing a plurality of symbols (40), each symbol having a value designation. The apparatus further includes presentation means for selecting two or more symbols (40) from the plurality of symbols and presenting the symbols to a user. The plurality of symbols are arrangeable in order of value designation. The apparatus also includes replacement means for replacing one or more of the selected symbols with one or more successive symbols from along the order of value designation.

### FIELD OF THE INVENTION

This invention relates to gaming apparatus.

### BACKGROUND OF THE INVENTION

Gaming apparatus for playing card games are known. However, such apparatus are limited in their scope for playing the games involved.

### SUMMARY OF THE INVENTION

According to one aspect of the present invention there is provided gaming apparatus comprising symbol providing means for providing a plurality of symbols, each symbol having a value designation, presentation means for selecting two or more symbols from said plurality of symbols and presenting the selected symbols to a user, said plurality of symbols being arrangeable in order of value designation, and replacement means for replacing one or more of the selected symbols with one or more successive symbols from along said order of value designation.

According to another aspect of this invention, there is provided a gaming method comprising providing a plurality of symbols, each symbol having a value designation, selecting two or more symbols from said plurality of symbols, presenting the selected symbols to a user, said plurality of symbols being arrangeable in order of value designation, and replacing one or more of said symbols with one or more successive symbols from along said order of value designation.

According to another aspect of the present invention there is provided gaming apparatus comprising symbol providing means for providing a plurality of symbols, each symbol having a value designation, presentation means for selecting two symbols from said plurality of symbols and presenting the selected symbols to a user, the presentation means selecting one or more symbols and replacing said selected symbols in turn with said further symbols until two pre-determined symbols are presented.

According to another aspect of this invention there is provided a gaming method comprising providing a plurality of symbols, each symbol having a value designation, selecting two symbols from said plurality of symbols and presenting the selected symbols to a user, selecting at least one further symbol and replacing said selected symbols in turn until two pre-determined symbols are presented.

Preferably, the plurality of symbols includes a plurality of sets of symbols.

According to another aspect of the present invention there is provided gaming apparatus comprising symbol providing means for providing a plurality of symbols, said plurality of symbols comprising a plurality of sets of symbols, each symbol having a value designation and a set designation, presentation means for selecting two or more symbols from said plurality of symbols and presenting the selected symbols to a user, said plurality of symbols being arrangeable in order of value designation, and replacement means for replacing one or more of the selected symbols with one or more successive symbols from along said order of value designation, wherein the, or each, successive symbol is selected from any of said sets.

According to another aspect of the present invention, there is provided a gaming method comprising providing a plurality of symbols, said plurality of symbols, said plurality of symbols comprising a plurality of sets of symbols, each symbol having a value designation and a set designation, selecting two or more symbols from said plurality of symbols, presenting the selected symbols to a user, said plurality of symbols being arrangeable in order of value designation, and replacing one or more of said symbols with one or more successive symbols from along said order of value designation, wherein the, or each, successive symbol is selected-from any of said sets.

According to another aspect of the present invention there is provided gaming apparatus comprising symbol providing means for providing a plurality of symbols, said plurality of symbols comprising a plurality of sets of symbols, each symbol having a value designation and a set designation, presentation means for selecting two or more of said symbols from said plurality of symbols, presentation means for selecting two or more symbols from all of said plurality of symbols and presenting the selected symbols to a user, said plurality of symbols being arrangeable in order of value designation, and replacement means for replacing one or more of the selected symbols with one or more successive symbols from along said order of value designation, wherein the, or each, successive symbol is selected from the same set as the symbol to be replaced.

According to another aspect of the present invention, there is provided a gaming method comprising providing a plurality of symbols, said plurality of symbols comprising a plurality of sets of symbols, each symbol having a value designation and a set designation, selecting two or more symbols from all of said plurality of symbols, presenting the selected symbols to a user, said plurality of symbols being arrangeable in order of value designation, and replacing one or more of the selected symbols with one or more successive symbols from along said order of value designation, wherein the, or each, successive symbol is selected from the same set as the symbol to be replaced.

In one embodiment, the symbols may be arranged in said order of value designation, preferably by the symbol providing means.

Preferably, the presentation means comprises selection means for selecting the aforesaid two or more symbols. The presentation means may comprise display means displaying the selected symbols, to be presented to the user.

The value designation of each symbol may be an alphabetical or numerical designation.

The order of values may be an alphabetical or numerical order. The symbols may provide a succession of symbols in alphabetical or numerical order.

Each set of symbols may comprise a plurality of symbols in which the value designations are alphabetical or numerical designations, and each set may provide a succession of symbols in alphabetical or numerical order. Each symbol may further include a set designation to define the sets to which the respective symbol belongs. For example, the symbols may be in the form of representations of playing cards, in which the sets constitute suits, whereby the value designation denotes the value of the respective playing card, and the set designation denotes the suit to which the respective card belongs.

In one embodiment, the, or each, aforesaid succession of symbols may comprise different symbols selected from any of said sets. In another embodiment, the, or each, aforesaid succession of symbols may comprise different symbols having the same set designations.

The symbol providing means may comprise storage means for storing representations of the symbols. The storage means, the selection means, and the replacement means may constitute a single processing means, or may be separate components of the apparatus.

The display means may comprise a screen on which the symbols are displayed.

Preferably, the presentation means is arranged to select the, or each, symbol substantially at random. The selection means may comprise electronic selection means which may be appropriately programmed.

The presentation means is preferably arranged to select three of said symbols.

The replacement means may be arranged to replace the selected symbol in a stepwise manner. Preferably, each stepwise change in the symbol is displayed on the display means. The replacement means may be arranged to replace the selected symbol, or one of the selected symbols in either direction along the succession of symbols as desired by a user.

The plurality of symbols may comprise a plurality of groups of symbols. Each group of symbols may comprise a plurality of sets as described above.

In the preferred embodiment, each group of symbols comprises representations of a pack of playing cards. Preferably, the plurality of symbols consists of three groups of symbols. In the preferred embodiment, the plurality of symbols comprises representations of three packs of playing cards.

The apparatus preferably further includes actuation means to allow the apparatus to be used by a user. The actuation means may comprise token receiving means, whereby upon receipt of a token, or a plurality of tokens, to a predetermined value, the actuation means may allow the user to operate the apparatus. The token receiving means may be adapted to receive tokens in the form of coins.

Preferably, the apparatus includes delivery means to deliver to a user a prize, which may be in the form of coins or other tokens, when the symbols, or, displayed on the display means match a predetermined arrangement of symbols

Means for retaining the symbols may be provided for a user to retain a symbol presented by the presentation means for the next operation of the apparatus. The retaining means may allow the operator to retain more than one of the symbols presented by the presentation means for the next operation of the apparatus. The retaining means may be a part of the processing means, or may be a separate component of the apparatus.

In an alternative embodiment, or in addition to the above the presentation means may select a first symbol and thereafter a second symbol, and may present the first and second symbols to the user. Thereafter the presentation means may select further symbols in turn, to replace the previously selected first or second symbols. This further selection may continue until two symbols of the same value are displayed.

### DESCRIPTION OF THE DRAWINGS

An embodiment of the invention will now be described by way of example only with reference to the accompanying drawings, in which:

FIG. 1 is a schematic sectional side view of gaming apparatus; and

FIG. 2 is a view along the lines II-II in FIG. 1.

### DESCRIPTION OF THE PREFERRED EMBODIMENT

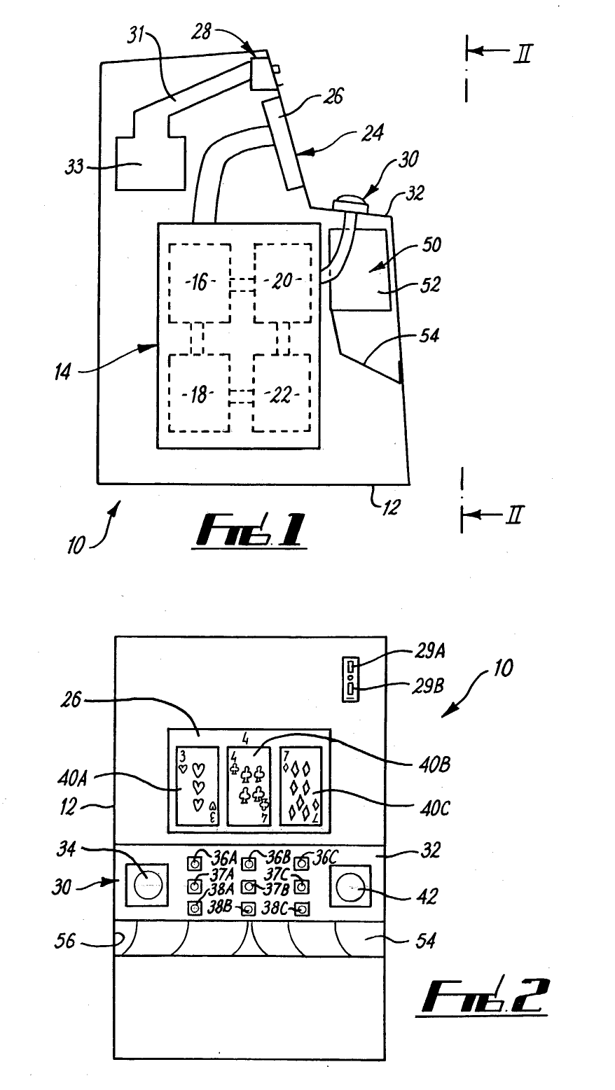

Referring to FIG. 1, there is shown a sectional side view of a gaming apparatus 10. The gaming apparatus 10 comprises a main body 12 housing the components thereof.

The components of the gaming apparatus 10 comprise processing means 14 which includes storage means 16 in the form of a memory for electronically storing a plurality of symbols in the form of representations of three packs of playing cards.

The processing means 14 further includes selection means 18 co-operable with the storage means 16 for selecting three individual playing cards.

Also included in the processing means, 14 is replacement means 20 for allowing the cards selected by the selection means 18 to be replaced. The processing means 14 also includes retaining means 22. The replacement means 20 and the retaining means 22 are described in more detail below.

The gaming apparatus 10 also includes display means 24 comprising a screen 26 for presenting the selected cards to a user.

Token receiving means 28 is provided towards the top of the main body 12 to receive, and recognise, tokens in the form of coins or other suitable means, such as a credit or debit card, or notes inserted therein. The token receiving means 28 defines a first slot 29A to receive the tokens and a second slot 29B out of which rejected tokens may pass. Where, for example, the tokens are coins, accepted tokens are passed via a chute 31 to a token holding chamber 33.

Also provided at the front of the main body 12 are control means 30 in the form of a plurality buttons, described below, which enable the user to operate the apparatus 10 when tokens to the correct value have been inserted into, and accepted by, the token receiving means 28.

Token delivery means 50 is provided, which holds a plurality of tokens. The tokens may be in the form of coins for delivery to a user as a prize. The token holding means 50 comprises a container 52 for containing the tokens and a chute 54 down which the tokens can slide. The main body 12 defines a slot 56 to allow access by the user to the tokens, on the chute 54.

The control means 30 is connected to the processing means 14 held within the main body 12 of the apparatus 10.

In the presently described embodiment, the processing means 14 comprises a single entity which includes within it, as represented in broken lines the storage means 16, the selection means 18, the replacement means 20, and the retaining means 22. It will be appreciated that the representations of the storage, selection, replacement, and retaining means 16, 18, 20, 22 are arbitrary representations of these features within the processing means 14. The person skilled in the art will realise from this description the components that would be required, and their arrangements within the processing means 14. It will also be appreciated that the processing means 14 need not be a single entity, the individual components as described herein, namely the storage means 16, the selection means 18, the replacement means 20, and the retaining means 22 may be individual components co-operating with one another connected electrically to one another.

The control means 30 is arranged on a front panel 32 of the apparatus and comprises a “start button” 34, three “step up” buttons, 36A, 36B, 36C, three “step down” buttons 37A, 37B, 37C, and three “hold” buttons 38A, 38B, 38C. The screen 26 is arranged directly above the control means 30.

When the start button 34 is pressed, the processing means 14, operates so that the selection means 18 selects, substantially at random, three playing cards from the three sets of representations of playing cards stored on the storage means 16. These three playing cards are displayed on the screen 26, as shown by the playing cards 40A, 40B, 40C. As can be seen, the buttons 36A, 37A, 38A are arranged directly beneath and operate on the representation of the card 40A and, correspondingly, the buttons 36B, 37B and 38B are arranged directly beneath and operate on, the representation of the card 40B on the screen 26, and the buttons 36C, 37C, 38C are arranged beneath and operate on, representation of the card 40C.

When the button 34 is pressed, three cards are displayed on the screen 26. Also displayed at the top of the screen is a number which is the maximum amount of changes which can be made to the cards on the screen by pressing the buttons 36A, 36B, 36C, 37A, 37B or 37C. In the example shown the number of changes that can be made is “4”. By pressing the “step up” button 36A, the adjustment means 20 changes the card 40A upwardly in numerical order. Similarly, by pressing the “step down” button 37A the adjustment means 20 changes the card 40A downwardly in numerical order, and the buttons 36B, 37B and 36C, 37C would have the same effect respectively to the cards 40B and 40C.

For example, if the cards which are selected and first appear on the screen 26 are a three of hearts, a four of clubs and a seven of diamonds as shown in FIG. 1 and the number of adjustments indicated on the screen is “4” (as shown) the user could press the “step up” button 36A once to change the three of hearts, to a four and the “step down” button 37C three times to change the seven of diamonds to a four which would give the user three fours. Alternatively, if the cards shown on the screen had been the three of clubs, the eight of spades, and the six of hearts, and the number of adjustments indicated on the screen was at least five, the user, by pressing the “step up” button 36A three times could change the three of clubs to a six, and by pressing the “step down” button 37B twice could change the eight of spades to a six thereby giving the user three sixes. In each case the user wins a prize and an appropriate number of coins are delivered down the chute 54 to be retrieved by the user.

During the process of changing the cards, the cards are arranged in numerical order and, if desired, in suit order. Thus, in the first example given above, the three of hearts would be changed to the four of hearts and the seven of diamonds to the four of diamonds. Similarly, with the second example, the three of clubs would be changed to the six of clubs and the eight of spades to the six of spades. However, if the cards are arranged in value order, but with random ordering of the suits, the user does not know which suit will be displayed on the screen when the buttons 36A-C and 37A-C are pressed.

In the first example indicated above, it will be possible to change the three of hearts to the four of clubs and the seven of diamonds also to the four of clubs if the suits are randomly ordered. The user is likely to win a higher prize if the three matching cards are identical rather than if they are of different suits.

It will be appreciated that in some embodiment, the representations of the cards may be stored in numerical order in the storage means 16, at least during the step of operating the replacement means 20. However, in other embodiments, the representations of the card may be stored in the storage means in any desired order, and the replacement means, 20 is programmed to replace the card 40A, 40B or 40C with the subsequent or previous card in numerical order.

When the user has completed the game, and decides to play again, on the insertion of appropriate coins to play a further game, the screen may indicate that some or all of the cards may be retained or “held”. The buttons 38A-38C are connected to the retaining means 22 which enables the user, on pressing a desired one or more of the buttons 38A-38C to retain the respective cards during the next game. For example, if, at the end of a previous game, the user has two sevens, and on insertion of coins to play a further game, the screen indicates that at least two “holds” are available, the player could choose to retain the two sevens for the next game.

The apparatus 10 also includes a random is action button 42 for playing a further game after the game described above has finished. The random action button 42 is connected to the processing means 14. If, at the end of a game described above, the screen shows a preselected arrangement of cards, the display may offer the user the opportunity to play a further game, and win further money. In this part of the game, if the user wishes to play, he presses the random is action button 42, and the selection means then selects a pair of cards at random. Subsequently the selection means then selects also at random cards in turn which alternately replace each of the two selected cards. This continues until the screen shows a pair of cards. At the beginning of the game the prize to be won may be, for example, fifteen pounds. Each time a card is dealt, after the first two cards have been dealt, the prize may be reduced by a predetermined amount, for example, one pound. When the cards on the screen constitute a pair, the user will win the amount remaining.

Various modifications can be made without departing from the scope of the invention, for example, then selection means could select more than three cards.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. Gaming apparatus comprising symbol providing means for providing a plurality of symbols, each symbol having a value designation, presentation means for selecting two or more symbols from said plurality of symbols and presenting the selected symbols to a user, said plurality of symbols being arrangeable in order of value designation, and replacement means for replacing one or more of the selected symbols with one or more successive symbols from along said order of value designation.

2. Gaming apparatus according to claim 1 wherein the plurality of symbols includes a plurality of sets of symbols, each symbol having a value designation and a set designation, and each successive symbol being selecting from any of said sets.

3. Gaming apparatus according to claim 1 wherein the presentation means comprises selection means for selecting the aforesaid symbols, and display means displaying the selected symbols, to be presented to the user.

4. Gaming apparatus according to claim 3 wherein the symbol providing means comprise storage means for storing representations of the symbols, the storage means, the selection means, and the replacement means constituting a single processing means, or may be separate components of the apparatus.

5. Gaming apparatus according to claim 1 wherein the presentation means is arranged to select the, or each, symbol substantially at random.

6. Gaming apparatus according to claim 5 wherein the presentation means is arranged to select three of said symbols.

7. Gaming apparatus according to claim 1 wherein the replacement means is arranged to replace the selected symbol in a stepwise manner, each stepwise change in the symbol being displayed on the display means.

8. Gaming apparatus according to claim 7 wherein the replacement means is arranged to replace the selected symbol, or one of the selected symbols in either direction along the succession of symbols as desired by a user.

9. Gaming apparatus according to claim 1 wherein the apparatus includes means for retaining the symbols for a user to retain a symbol presented by the presentation means for the next operation of the apparatus.

10. Gaming apparatus according to claim 9 wherein the retaining means is arranged to allow the operator to retain more than one of the symbols presented by the presentation means for the next operation of the apparatus.

11. Gaming apparatus according to claim 1 wherein the above the presentation means is adapted select a first symbol and thereafter a second symbol, and to present the first and second symbols to the user, and the presentation means is further adapted to select further symbols in turn, to replace the previously selected first or second symbols, said further selection continuing until two symbols of the same value are displayed.

12. Gaming apparatus comprising symbol providing means for providing a plurality of symbols, each symbol having a value designation, presentation means for selecting two symbols from said plurality of symbols and presenting the selected symbols to a user, the presentation means selecting one or more symbols and replacing said selected symbols in turn with said further symbols until two pre-determined symbols are presented.

13. Gaming apparatus according to claim 12 wherein the plurality of symbols includes a plurality of sets of symbols, each symbol having a value designation and a set designation, and each successive symbol being selecting from any of said sets.

14. Gaming apparatus according to claim 12 wherein the presentation means comprises selection means for selecting the aforesaid symbols, and display means displaying the selected symbols, to be presented to the user.

15. Gaming apparatus according to claim 14 wherein the symbol providing means comprise storage means for storing representations of the symbols, the storage means, the selection means, and the replacement means constituting a single processing means, or may be separate components of the apparatus.

16. Gaming apparatus according to claim 12 wherein the presentation means is arranged to select the, or each, symbol substantially at random.

17. Gaming apparatus according to claim 12 wherein the above the presentation means is adapted select a first symbol and thereafter a second symbol, and to present the first and second symbols to the user, and the presentation means is further adapted to select further symbols in turn, to replace the previously selected first or second symbols, said further selection continuing until two symbols of the same value are displayed.

18. A gaming method comprising providing a plurality of symbols, each symbol having a value designation, selecting two or more symbols from said plurality of symbols, presenting the selected symbols to a user, said plurality of symbols being arrangeable in order of value designation, and replacing one or more of said symbols with one or more successive symbols from along said order of value designation.

19. A gaming method according to claim 18 wherein the plurality of symbols includes a plurality of sets of symbols, each symbol having a value designation and a set designation, and each successive symbol being selecting from any of said sets.

20. A gaming method according to claim 18 wherein the presentation means comprises selection means for selecting the aforesaid symbols, and display means displaying the selected symbols, to be presented to the user.

21. A gaming method according to claim 20 wherein the symbol providing means comprise storage means for storing representations of the symbols, the storage means, the selection means, and the replacement means constituting a single processing means, or may be separate components of the apparatus.

22. A gaming method according to claim 18 wherein the presentation means is arranged to select the, or each, symbol substantially at random.

23. A gaming method according to claim 22 wherein the presentation means is arranged to select three of said symbols.

24. A gaming method according to claim 1 wherein the replacement means is arranged to replace the selected symbol in a stepwise manner, each stepwise change in the symbol being displayed on the display means.

25. A gaming method according to claim 24 wherein the replacement means is arranged to replace the selected symbol, or one of the selected symbols in either direction along the succession of symbols as desired by a user.

26. A gaming method according to claim 18 wherein the apparatus includes means for retaining the symbols for a user to retain a symbol presented by the presentation means for the next operation of the apparatus.

27. A gaming method according to claim 26 wherein the retaining means is arranged to allow the operator to retain more than one of the symbols presented by the presentation means for the next operation of the apparatus.

28. A gaming method according to claim 18 wherein the above the presentation means is adapted select a first symbol and thereafter a second symbol, and to present the first and second symbols to the user, and the presentation means is further adapted to select further symbols in turn, to replace the previously selected first or second symbols, said further selection continuing until two symbols of the same value are displayed.

29. A gaming method comprising providing a plurality of symbols, each symbol having a value designation, selecting two symbols from said plurality of symbols and presenting the selected symbols to a user, selecting at least one further symbol and replacing said selected symbols in turn until two pre-determined symbols are presented.

30. A gaming method according to claim 29 wherein the plurality of symbols includes a plurality of sets of symbols, each symbol having a value designation and a set designation, and each successive symbol being selecting from any of said sets.

31. A gaming method according to claim 29 wherein the presentation means comprises selection means for selecting the aforesaid symbols, and display means displaying the selected symbols, to be presented to the user.

32. A gaming method according to claim 31 wherein the symbol providing means comprise storage means for storing representations of the symbols, the storage means, the selection means, and the replacement means constituting a single processing means, or may be separate components of the apparatus.

33. A gaming method according to claim 29 wherein the presentation means is arranged to select the, or each, symbol substantially at random.

34. A gaming method according to claim 29 wherein the above the presentation means is adapted select a first symbol and thereafter a second symbol, and to present the first and second symbols to the user, and the presentation means is further adapted to select further symbols in turn, to replace the previously selected first or second symbols, said further selection continuing until two symbols of the same value are displayed.
